(19) United States
(12) Patent Application Publication
(10) Pub. No.: US 2014/0073148 A1
(43) Pub. Date: Mar. 13, 2014

(54) CONFIGURABLE ELECTRICAL CONNECTOR

(71) Applicant: Stéphane Gallerand, Jouy le Moutier (FR)

(72) Inventor: Stéphane Gallerand, Jouy le Moutier (FR)

(73) Assignee: TYCO ELECTRONICS FRANCE SAS, Pontoise (FR)

(21) Appl. No.: 14/008,146

(22) PCT Filed: Mar. 27, 2012
(86) PCT No.: PCT/EP12/55429

§ 371 Date: Sep. 27, 2013

(30) Foreign Application Priority Data
Mar. 30, 2011 (FR) 1152640

(51) Int. Cl. H01R 12/71

(52) U.S. Cl. CPC H01R 12/716
USPC 439/76.1

(57) ABSTRACT

The present invention relates to a configurable electrical connector (1100), to a lock (1200) and to a configured electrical connector (1300). More specifically, it relates to an electrical connector (1300) which can be configured so as to be mounted, by means of at least one lock (1200), on a mounting target in more than one position.

The present invention relates to a configurable electrical connector, to a lock and to a configured electrical connector. More specifically, it relates to an electrical connector which can be configured so as to be mounted, by means of at least one lock, on a mounting target in more than one position.

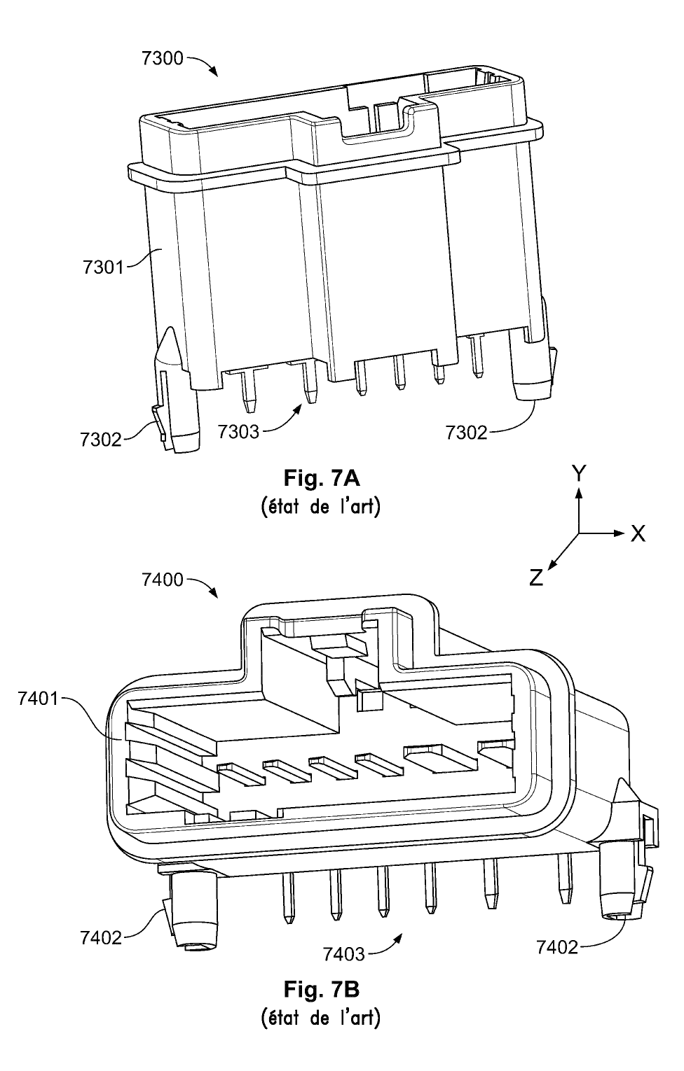

Electrical plug-in connectors are known in the prior art to have at least two shapes. For instance, as can be seen in FIG. 7A, electrical connector 7300 has a body 7301 mainly extending in the X and Y direction, including PCB locks 7302 mainly extending in the Y direction. Thanks to this construction, the electrical connector 7300 can be mounted on a PCB, by engaging the PCB lock 7302 into predetermined holes within the PCB. In this manner, contact is ensured between the leads 7303 of electrical connector 7300 and the respective contact points on the PCB.

Similarly, electrical connector 7400 has a body 7401 extending mainly in the X and Z directions. PCB locks 7402 are integrally molded with the body 7401 and extend mainly in a direction Y so as to realize a 90° angle with the main body. Leads 7403 extend in the same direction of PCB locks so as to realize a connection with the corresponding contacts on the PCB when the PCB locks 7402 are engaged with the PCB.

Accordingly, it is known how to realize a straight connector 7300 of FIG. 7A and a 90° bent connector 7400 as in FIG. 7B.

However, the realization of those two different connectors requires two different molding equipments since the shape of the two connectors 7300 and 7400 is different. This has the disadvantage that costs are increased for the manufacturing of the two connectors since twice the machinery is necessary, which also results in more space to be used within the manufacturing plant as well as more maintenance for the additional machinery, all factors adding up and resulting in increased manufacturing costs.

The above mentioned problems are solved by a configurable connector according to the present invention where a configurable electrical connector includes at least one engaging means for engaging at least one lock, for mounting the connector to a mounting target, in at least two positions.

Thanks to such an arrangement, it is possible to manufacture a single type of configurable electrical connector which can be assembled with at least one lock in at least two positions, so as to be mounted in at least two positions.

In some embodiments, the at least one engaging means can be configured so as to allow engagement/prevent disengagement of the lock with/from the configurable electrical connector.

Thanks to such an arrangement, the lock can easily be engaged with the configurable electrical connector, and accidental disengagement is prevented.

In some embodiments, the at least one engaging means can have a plurality of protrusions separated by at least one space, wherein at least one of the protrusions can be provided with a locking means configured so as to allow engagement/prevent disengagement of the lock with/from the configurable electrical connector.

Thanks to such an arrangement, the lock can easily be engaged with the configurable electrical connector, and accidental disengagement is prevented with a simple structure for the engaging means.

In some embodiments, the at least one engaging means can have a circular section.

Thanks to such an arrangement, the lock can be rotated around the engaging means.

In some embodiments, the configurable electrical connector can further comprise at least one rotating stop, and the lock can comprise at least one indentation, such that the lock can be engaged with the configurable electrical connector in at least one position when the at least one rotating stop is inserted into the at least one indentation.

Thanks to such an arrangement, the rotation of the lock around the engaging means is restricted so that during assembly of the lock to the configurable electrical connector, the lock can be assembled in at least two stable positions.

In some embodiments, the at least one engaging means can have a section such that, once the lock is engaged with the configurable electrical connector, the lock is prevented from rotating on the at least one engaging means.

Thanks to such an arrangement movement of the lock around the engaging means is prevented, without the use of any rotating stops or any indentations.

In some embodiments, the section can be configured to allow the lock to be engaged on the configurable electrical connector in at least two positions.

Thanks to such an arrangement, the movement of the lock around the engaging means is restricted so that during assembly of the lock to the configurable electrical connector, the lock can be assembled in at least two stable positions.

According to an embodiment of the present invention, a lock for a configurable electrical connector, for mounting the configurable electrical connector on a mounting target, can comprise a hole with a section substantially similar to the section of the at least one engaging means of the configurable electrical connector.

Thanks to such an arrangement, the lock can easily be mounted and engaged on the configurable electrical connector via the engaging means.

In some embodiments, the lock can further comprise a mounting pin for engaging the at least one lock to the mounting target.

Such an arrangement allows mounting the lock and the configured electrical connector to a mounting target.

In some embodiments, the mounting pin can comprise at least one locking means for preventing disengagement of the lock from the mounting target.

Thanks to such an arrangement, the lock, and therefore the configured electrical connector, can easily be engaged with the mounting target by sliding the mounting pin into the mounting target, while accidental disengagement is prevented.

In some embodiments, the lock can further comprise at least one stopping means for stopping movement of the lock toward the mounting target.

Thanks to such an arrangement, the lock can be mounted on the mounting target in a stable manner.

In some embodiments, the lock can further comprise at least one coding means for determining the mounting direction of the lock on the mounting target.

Thanks to such an arrangement, accidental mounting of the configured electrical connector on the mounting target in a wrong direction is prevented.

According to an embodiment of the present invention, a configured electrical connector can include a configurable electrical connector and at least one lock according to the previously mentioned embodiments of the present invention.

Thanks to such an arrangement, the configured electrical connector can be assembled with the lock in at least two different positions, while only one kind of lock and one kind of configurable electrical connector are manufactured.

The invention will be described in more detail by way of example hereinafter using advantageous embodiments and with reference to the drawings. The described embodiments are only possible configurations in which the individual features may however, as described above, be implemented independently of each other or may be omitted. Equal elements illustrated in the drawings are provided with equal reference signs. Parts of the description relating to equal elements illustrated in the different drawings may be left out. In the drawings:

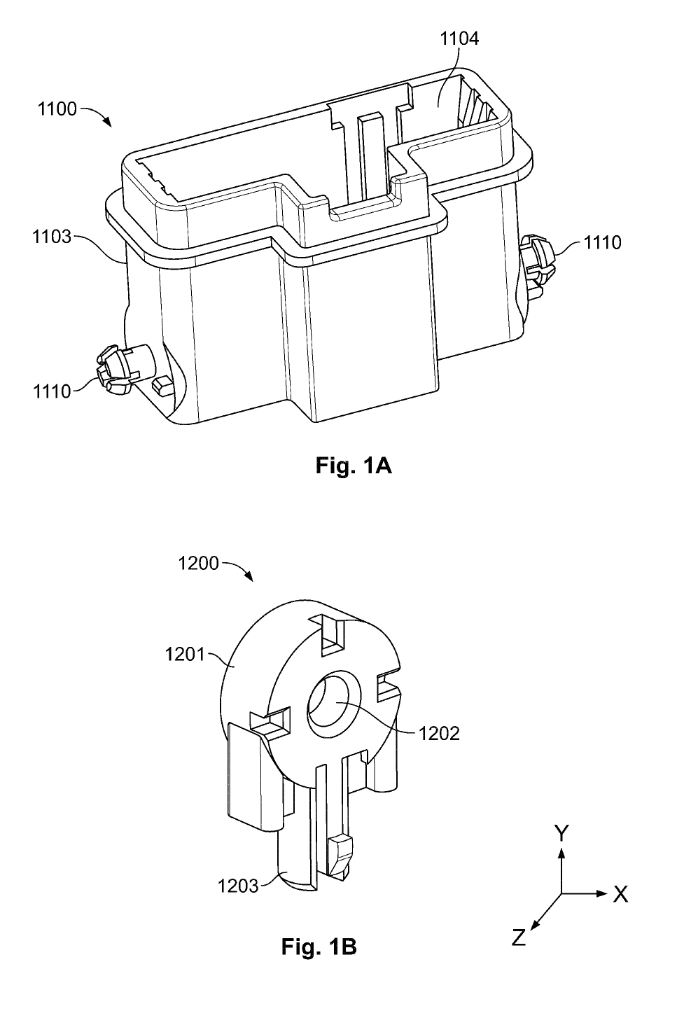

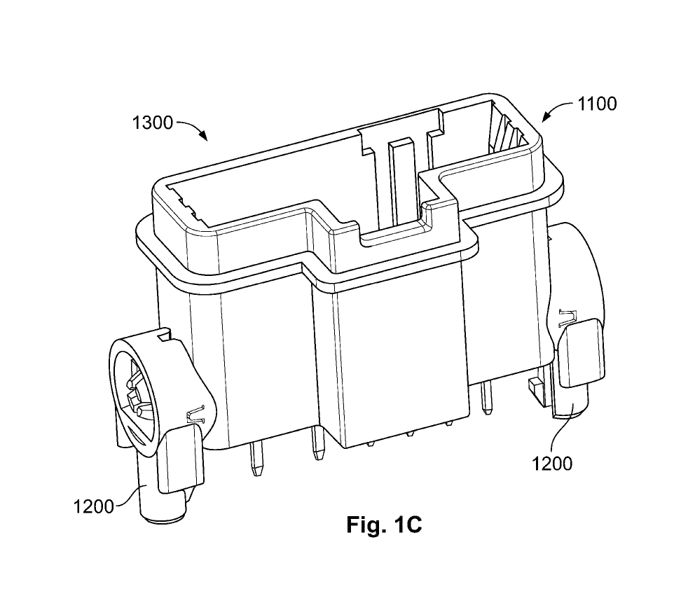

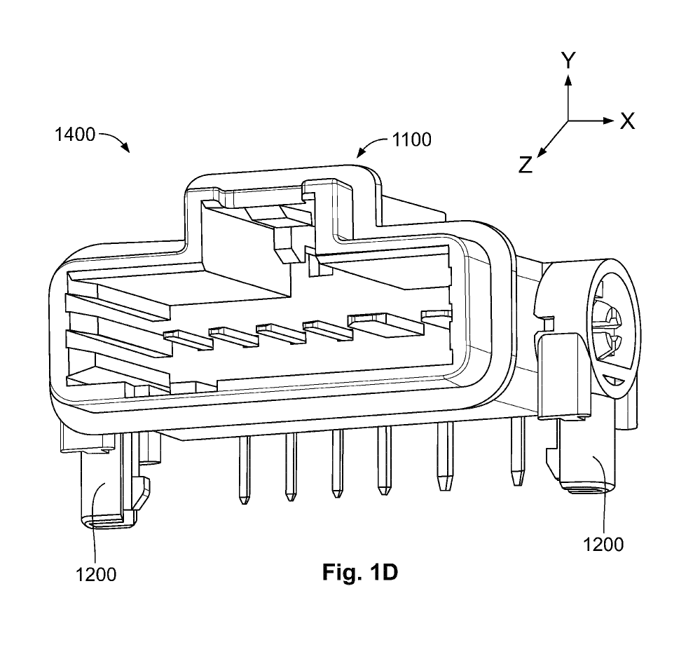

FIG. 1A is a schematic perspective view of a configurable electrical connector according to an embodiment of the present invention;

FIG. 1B is a schematic perspective view of a PCB lock which can be engaged with the configurable electrical connector of FIG. 1A;

FIGS. 1C and 1D are schematic perspective views of two possible arrangements of the configurable electrical connector and the PCB locks of the present invention;

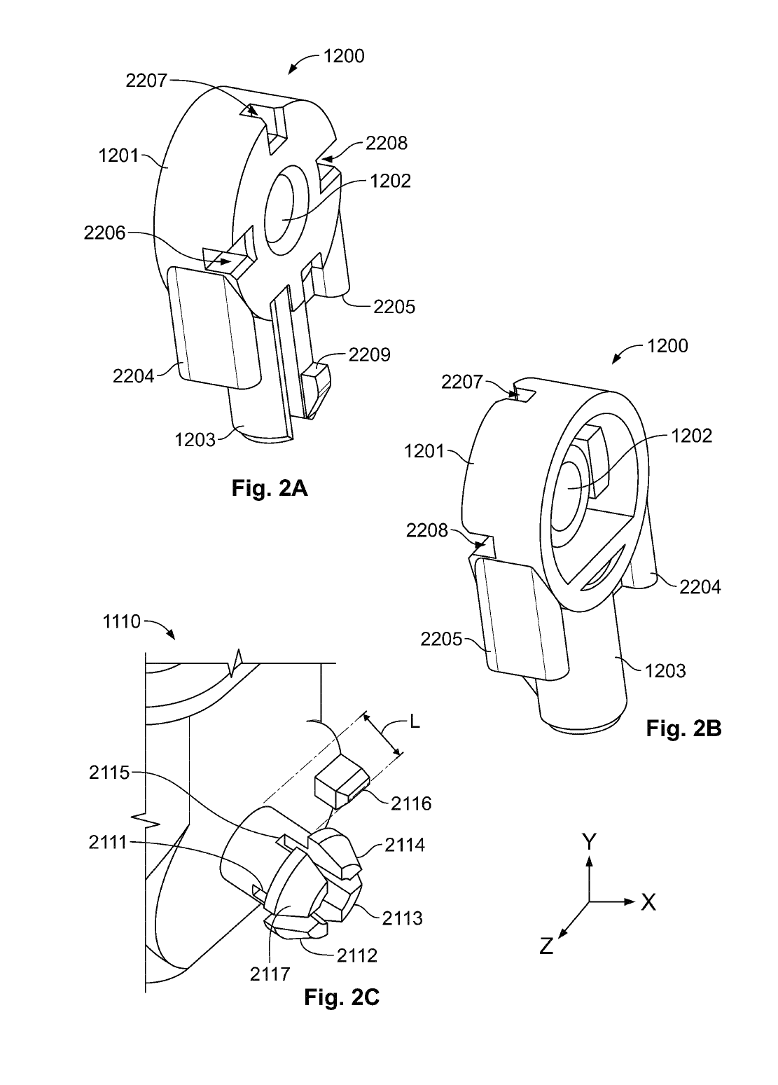

FIGS. 2A and 2B are schematic perspective views of a PCB lock according to an embodiment of the present invention;

FIG. 2C is a schematic perspective view of an engaging means of the configurable electrical connector according to an embodiment of the present invention;

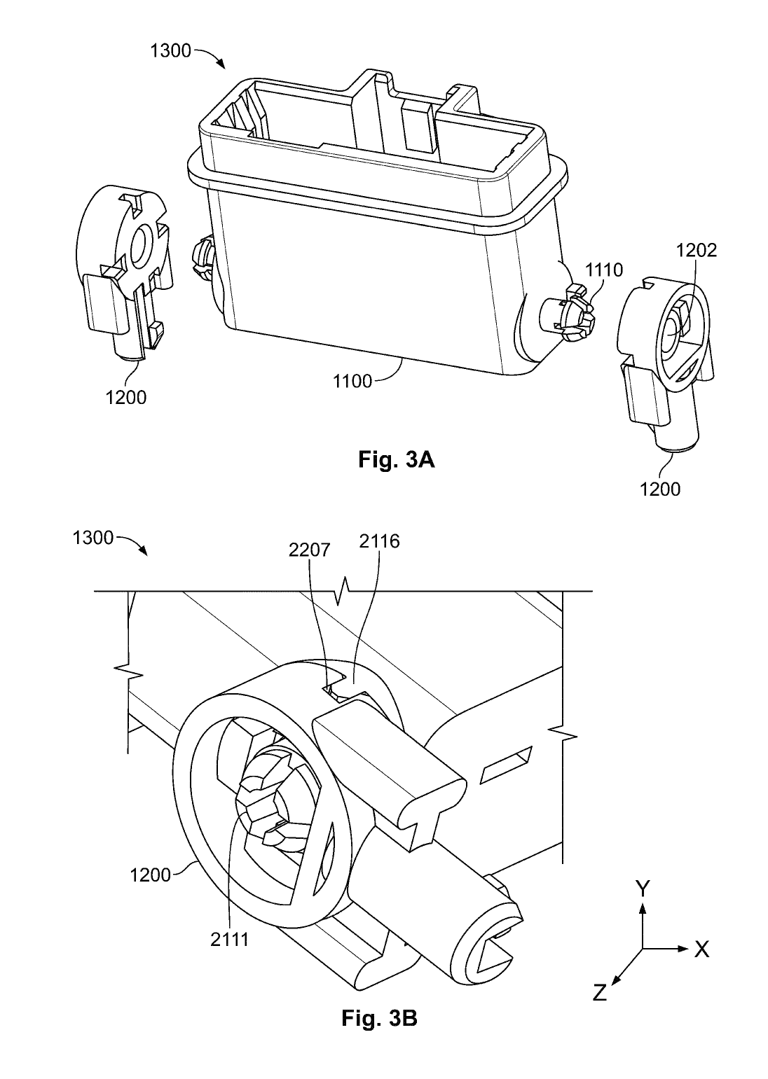

FIG. 3A is a schematic perspective view of a placement of two PCB locks and one configurable electrical connector, before engagement of the PCB locks on the configurable electrical connector, according to an embodiment of the present invention;

FIG. 3B is a schematic perspective view of one PCB lock engaged in a first position by engaging means of a configurable electrical connector according to an embodiment of the present invention;

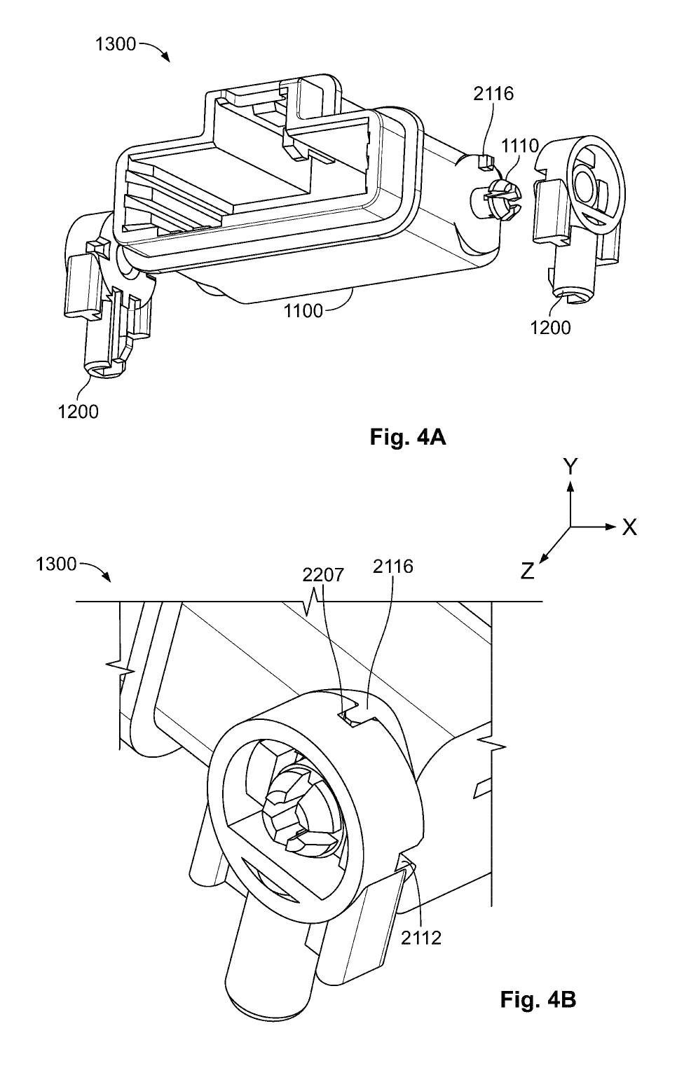

FIG. 4A is a schematic perspective view of an alternative placement of two PCB locks and one configurable electrical connector, before engagement of the PCB locks on the configurable electrical connector, according to an embodiment of the present invention;

FIG. 4B is a schematic perspective view of one PCB lock engaged in a second position by engaging means of a configurable electrical connector according to an embodiment of the present invention;

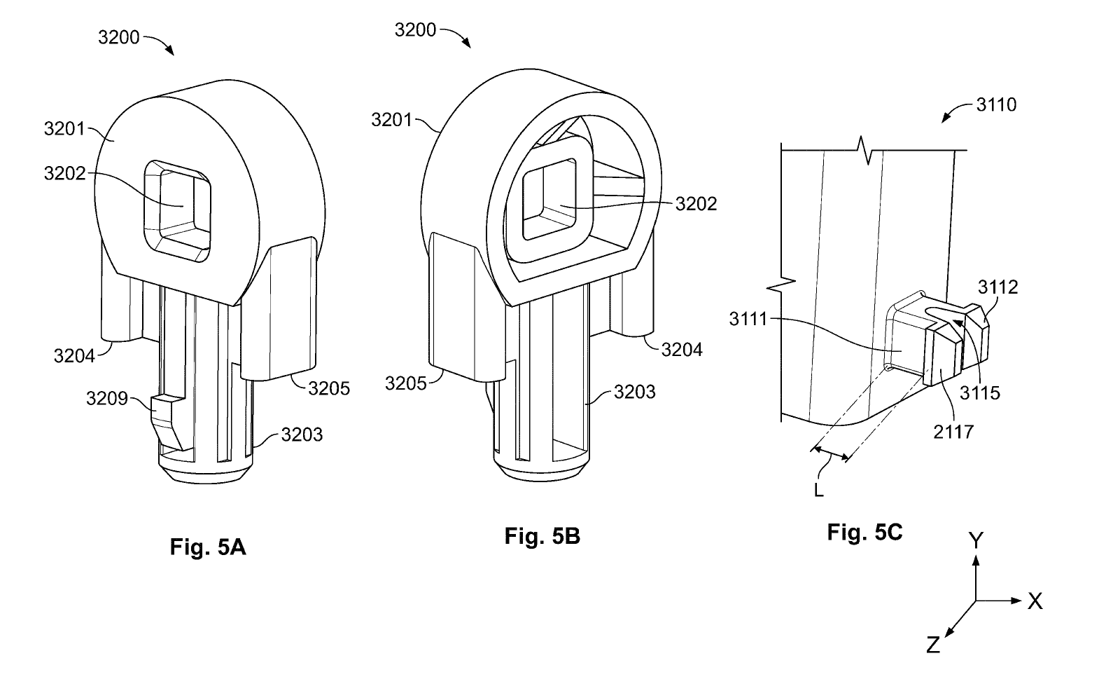

FIGS. 5A and 5B are schematic perspective views of a PCB lock according to an embodiment of the present invention;

FIG. 5C is a schematic perspective view of an engaging means of the configurable electrical connector according to an embodiment of the present invention;

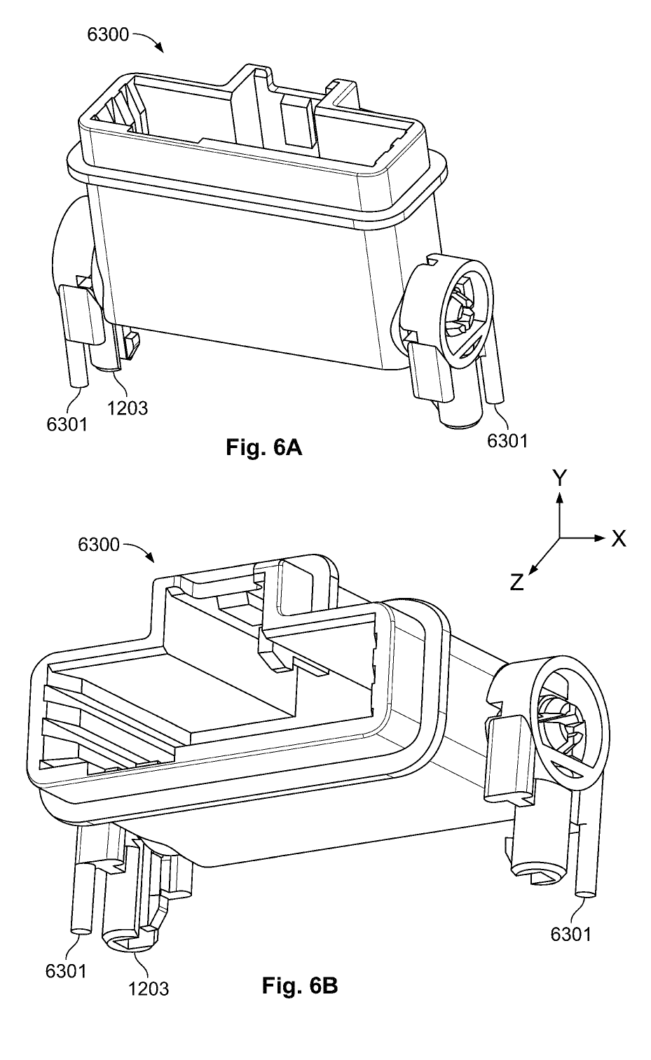

FIG. 6A is a schematic perspective view of a configurable electrical connector having two PCB locks engaged in a first position according to an embodiment of the present invention;

FIG. 6B is a schematic perspective view of a configurable electrical connector having two PCB locks engaged in a second position according to an embodiment of the present invention;

FIG. 7A is a perspective schematic view of a straight electrical connector in accordance with the prior art;

FIG. 7B is a perspective schematic view of a 90° bent electrical connector in accordance with the prior art.

A configurable electrical connector 1100 is described with reference to FIG. 1A, which shows the configurable electrical connector 1100 in a schematic perspective view. The configurable electrical connector 1100 comprises a body 1103, mainly extending in directions X and Y. The body 1103 comprises a cavity 1104 in which an electrical plug, mating with the configurable electrical connector, can be engaged. Moreover, connected to the body 1103, are two engaging means 1110 mainly extending in direction X. The purpose of the engaging means 1110 is to engage with PCB locks, as will be described later, so as to allow the configurable electrical connector 1100 to be mounted on a PCB.

FIG. 1B is a schematic perspective view of a PCB lock 1200, engagable with the configurable electrical connector 1100. The PCB lock 1200 comprises a body 1201 including a mounting pin 1203. In the body 1201, a hole 1202 is realized. The hole 1202 is shaped so as to allow the passage of engaging means 1110 in at least one direction.

In such a way, the PCB lock 1200 can be engaged on the electrical connector 1100 by sliding the engaging means 1110 within the hole 1202. This provides the beneficial advantage that the PCB lock 1200 can be engaged with the configurable electrical connector 1100 in more than one position, since it is not integrally molded with the body 1103 of the configurable electrical connector 1100.

For instance, a configured electrical connector 1300 such as the one represented in FIG. 1C can be obtained. In the configured electrical connector 1300, two PCB locks 1200 are connected to the configurable electrical connector 1100 so as to extend in the Y direction, while the configurable electrical connector 1100 is also extending the Y direction. In such a way, a straight configured electrical connector 1300 can be realized.

On the other hand, a configured electrical connector 1400 illustrated in FIG. 1D is realized by engaging the PCB locks 1200 extending the Y direction with the electrical connector 1100 extending the Z direction. In such a manner, a 90° bent configured electrical connector 1400 can be obtained.

Next, a PCB lock 1200 will be described in details with reference to FIGS. 2A and 2B.

As can be seen in FIG. 2A, PCB lock 1200 comprises a body 1201 including a mounting pin 1203. The purpose of the mounting pin 1203 is to slide within a predetermined hole in a PCB so as to engage the PCB lock 1200 with the PCB. The mounting pin 1203 includes a locking means 2209. The purpose of the locking means 2209 is to firmly engage the PCB locks with the PCB such that the PCB lock 1200 cannot be removed from the PCB after engagement. To this end, the locking means 2209 gradually increases the section of the mounting pin 1203, in a direction along the mounting pin moving away from the end of the mounting pin. The locking means 2209 gradually increases the section of the mounting pin 1203 until a point at which the locking means 2209 ends substantially abruptly. This arrangement ensures that once the locking means has passed through the hole in the PCB in which the mounting pin 1203 is to be inserted, disengagement of the mounting pin 1203 from the PCB become impossible, or requires more force than the force required for the engagement of the mounting pin 1203 with the PCB.

The PCB lock 1200 further includes at least one stopping means 2204 and 2205, the purpose of which is to provide a stable engagement of the PCB lock 1200 with the PCB. More specifically, the length of the stopping means 2204, 2205 along the mounting pin 1203, as well the position of the locking means 2209 on the mounting pin 1203 can be arranged, depending on the thickness of the PCB, so as to provide a stable engagement of the PCB lock 1200 on the PCB. More specifically, the distance between the substantially abrupt end of the locking means 2209 and the stopping means 2206 substantially corresponds to the thickness of the PCB.

Moreover, PCB lock 1200 includes at least two indentations 2206, 2207 and 2208. The plurality of indentations is provided so as to determine the position of PCB lock 1200 with respect to the body 1203 of the configurable electrical connector 1100 once the PCB lock 1200 is engaged on the configurable electrical connector 1100. More specifically, at least one of the indentations 2206, 2207 and 2208 will engage with at least one rotating stop 2116, present on the body 1203 of the configurable electrical connector 1100 as will be described later.

Since a plurality of indentation is provided on the PCB lock 1200, upon engagement of the PCB lock 1200 on the configurable electrical connector 1100, it is possible to determine a plurality of extending directions of the PCB lock 1200 with respect to the extending direction of the body 1103 of the configurable electrical connector 1100. More specifically, by properly selecting in which of the plurality of the indentations 2206, 2207 and 2208, the at least one rotating stop 2116 is inserted, the extending direction of the PCB lock 1200 with respect to the extending direction of the body 1103 of the configurable electrical connector 1100 can be determined.

Moreover, by realising the plurality of indentations 2206, 2207, and 2208 at predetermined positions on the body 1201 of the PCB lock 1200, any angle between the extending direction of the PCB lock 1200 and the body 1103 of the configurable electrical connector 1100 can be achieved.

FIG. 2C is a schematic perspective view of the part of the body 1103, of the configurable electrical connector 1100, including the engaging means 1110. As can be seen in FIG. 2C, at least one rotating stop 2116 is placed on the body 1103. The dimensions of the rotating stop 2116 are such that the rotating stop can be firmly engaged with at least one of the indentations 2206, 2207 and 2208 on the PCB lock 1200. By choosing which one, among the plurality of indentations, is engaged with the rotating stop 2116, the extending direction of the PCB lock 1200 with respect to the extending direction of the body 1103, of the configurable electrical connector 1100, can be determined.

Although only one rotating stop 2116 is represented in FIG. 2C, the present invention is not limited to this and a plurality of rotating stops 2116 could be realized instead. Any number of rotating stop 2116 and indentations 2206, 2207 and 2208 can be realized as long as it is ensured that the plurality of rotating stops and the plurality of indentations can be engaged in at least two different positions, when the PCB lock 1200 is engaged, via the engaging means 1110, on the configurable electrical connector 1100.

For instance, a plurality of rotating stops 2116 could be realized so as to be equally spaced by 90° around engaging means 1110. Similarly, a plurality of indentations 2206, 2207 and 2208 could be realized so as to be spaced from each other by 90° around hole 1202. With such a distribution of rotating stops and indentations, the PCB lock 1200 could be engaged on the configurable electrical connector 1100 in four different positions, each position being 90° apart from the two neighbouring positions. The same effect could be achieved by employing only one rotating stop 2116 and a plurality of indentations 2206, 2207 and 2208 separated from each other by 90° angles. Accordingly, in such a case, the decision to employ one rotating stop 2116 or a plurality of rotating stops 2116 could be made depending on factors other than the desired final position of the PCB lock 1200 with respect to the extending direction of the configurable electrical connector 1100. Such factors might be, for instance, the reliability and/or the strength of the engagement of the rotating stop(s) 2116 with the plurality of indentation 2206, 2207 and 2208.

As can be seen in FIG. 2C, engaging means 1110 comprise a plurality of protrusions 2111, 2112, 2113 and 2114 separated from each other by a plurality of spaces 2115. For instance, as can be seen in FIG. 2C, the protrusions 2111 to 2114 are placed substantially in a circular position, thereby resulting in a substantially circular section of the engaging means 1110.

Moreover, at least, one of the plurality of protrusions 2111 to 2114 is shaped so as to allow engagement of the PCB lock 1200 and so as to prevent disengagement of the PCB lock 1200 from the engaging means 1110. This is achieved thanks to at least one locking means 2117. More specifically, the section of the engaging means 1110 is substantially constant from the body 1103, of the configurable electrical connector 1100, along a predetermined distance L from the body 1103 until the locking means 2117. The distance L is chosen so as to substantially correspond to the length of the hole 1202 of the PCB lock 1200. After the distance L, the locking means 2117 abruptly increases the area of the section of the engaging means 1110. Moving further away from the body 1103 of the configurable electrical connector 1100, the area of the section of the engaging means 1110 gradually decreases. The abruptly increased area of the section of the engaging means 1110 at the distance L from the body 1103 is substantially larger that the area of the section of the hole 1202. However, even such larger area section can be pushed through the hole 1202, thanks to the plurality of spaces 2115 provided between the plurality of protrusions 2111 to 2114. In such a way, once the PCB lock 1200 is placed so as to have the hole 1202 substantially corresponding to the position of the engaging means 1110 and it is pushed towards the body 1103, the plurality of protrusions 2111 to 2114 are pressed towards each other, so as to allow sliding of the engaging means 1110 within hole 1202. Since the length L of the substantially constant circular section of the engaging means 1110 is substantially similar to the length of the hole 1202, the abruptly enlarged section of the engaging means 1110 will eventually come out of hole 1202 once the PCB lock 1200 substantially touches with the body 1103 of the configurable electrical connector 1100. When this happens, the plurality of protrusions 2111 to 2114 will revert to their normal position, thereby firmly engaging PCB lock 1200 with the configurable electrical connector 1100, thanks to the at least one locking means 2117.

Such an engaging procedure is represented in FIGS. 3A and 3B.

As can be seen in FIG. 3A, a configurable electrical connector 1100 having two engaging means 1110 is placed alongside two PCB locks 1200. More specifically, the hole 1202 of each of the PCB locks 1200 is disposed in front of a corresponding engaging means 1110 of the configurable electrical connector 1100. The axis of the hole 1202 is substantially parallel to the extending direction of the engaging means 1110. By pushing the PCB locks 1200 toward the body 1103 of the configurable electrical connector 1100, a stable and firm engagement of the PCB locks 1200 with the configurable electrical connector 1100 can be achieved.

In FIG. 3A, the body 1103 of the configurable electrical connector 1100 mainly extends along directions X and Y. At the same time, the two PCB locks 1200 mainly extend in the Y direction. Accordingly, when the PCB locks 1200 are pushed toward the configurable electrical connector 1100, a configured electrical connector 1300 including two firmly attached PCB locks 1200 can be realized. In such a case, the extending direction of the PCB locks 1200 would substantially correspond to the plug-in direction of the configured electrical connector 1300, thereby realising a straight electrical connector such as electrical connector 1300 of FIG. 1C.

FIG. 3B is a schematic perspective view of the engagement of the PCB locks 1200 on one side of the configurable electrical connector 1300. As can be seen from FIG. 3B, the movement of the PCB locks around the engaging means 1110 is prevented, since the rotating stop 2116 firmly engages with the indentation 2207 of PCB locks 1200. Moreover, disengagement of the PCB lock 1200 from the configured electrical connector 1300 is prevented, since the protrusions 2111 to 2114 are provided with locking means 2117, so as to realize an area of the section of engaging means 1110 larger than the hole 1202. Accordingly, the movement of the PCB locks 1200 away from the body of the configured electrical connector 1300 is prevented, by the larger section of the engaging means 1110 in correspondence with locking means 2117, once the PCB lock 1200 is engaged by engaging means 1110.

FIGS. 5A and 5B represent an alternative embodiment of the present invention. More specifically, the PCB locks 3200 of FIGS. 5A and 5B differ from the PCB locks 1200 of FIGS. 2A and 2B due to the absence of indentations 2206, 2207 and 2208 and due to a different section of the hole 3202 when compared to the hole 1202. More specifically, the hole 3202 has a non-circular section such as a square section, as represented in FIGS. 5A and 5B.

In order to be compliant with PCB locks 3200, an alternative engaging means 3110 is realized and is represented in FIG. 5C. Engaging means 3110 differ from engaging means 1110 in that it has a non-circular section, substantially similar to the non-circular section of hole 3202. At the same time, the engaging mechanism of engaging means 3110 is substantially similar to the engaging mechanism of engaging means 1110. More specifically, engaging means 3110 has at least two protrusions 3111 and 3112 separated by a space 3115. At least one of the two protrusions has a locking means 3117 such that two protrusions have a section which is constant for a length L from the body toward the locking means and is then substantially abruptly increased so as to prevent disengagement of the PCB lock 3200 once engaged on the configurable electrical connector. After the substantially abrupt increase in the section area, the locking means 3117 is configured so as to gradually reduce the section area of the engaging means 3110, such that the locking means has, at its end farthest from the body 1103, an area section which is substantially similar to the area section along the length L.

The non-circular section of hole 3202 and the substantially similar non-circular section of engaging means 3110 provides the beneficial advantage that the PCB locks 3200 cannot freely rotate around engaging means 3110. More specifically, for instance, if the section is substantially square, there are only four positions in which the PCB locks 3200 can be engaged on engaging means 3110. Similarly, if the section is substantially triangular, the number of positions in which the PCB lock can be arranged is reduced to 3. More generally speaking, by using a section having n sides, the number of possible placements of the PCB lock 3200 on the engaging means 3110 is n.

The embodiment depicted in FIGS. 5A to 5C therefore has the further advantage that no indentations 2206, 2207 and 2208, nor any rotation stop 2116 have to be realized.

A further embodiment of the present invention is illustrated in FIGS. 6A and 6B. FIGS. 6A and 6B are schematic perspective views of a configurable electrical connector 6300 in which the PCB locks 1200 additionally include a PCB coding pin 6301.

As can be seen in FIGS. 6A and 6B, the PCB coding pin 6301 extends in a manner substantially parallel to mounting pin 1203. Accordingly, in order to mount the configurable electrical connector 6300 on a PCB, in addition to a hole in the PCB for each of the mounting pins 1203, at least one coding hole for each of the coding pin 6301 is to be provided. The specific placement of the coding hole and the mounting hole on the PCB dictates the direction in which the PCB locks 6200 can be inserted within and engaged with the PCB. Accordingly, this dictates the direction in which the configurable electrical connector 6300 can be mounted on the PCB. This is advantageous since it prevents the configurable electrical connector 6300 to be mounted in a wrong manner on a PCB.

Although the locks 1200, 3200 and 6200 have been described as PCB locks for engaging the configured electrical connector on a PCB, the present invention is not limited to this. Alternatively, or in addition, the locks 1200, 3200 and 6200 may be configured so as to lock the configured electrical connector with any surface, for instance, to another electrical connector, as long as they are realized so that they can be engaged on at least two positions on the engaging means. More generally, the locks 1200 and 3200 can be used for mounting the configured electrical connector to any mounting target such as a PCB, a plastic or metal board, a wall, or another electrical connector.

Although locking means 2117 and 3117 have been described in combination to a plurality of protrusion separated by spaces, so as to prevent disengagement of the PCB locks 1200, 3200, 6200, the present invention is not limited to this. Alternatively, or in addition, other configurations for the engaging means 1110, 3110 can be realized. For instance, engaging means 1110 could be replaced by a cylinder having a circular section substantially similar to hole 1200 and with a hole on its surface furthest from the body 1103. Upon engaging the PCB lock 1200, a screw could be screwed in the hole on the cylinder surface, so as to prevent disengagement of the PCB lock 1200. More generally speaking any combination of engaging means 1110, 3110 and PCB lock 1200 and 3200 can be realized, as long as it allows engagement and prevents disengagement of the PCB locks 1200 and 3200 and of the configurable electrical connectors 1100 and 3100, respectively.

Similarly, although locking means 2209, 3209 and stopping means 2204, 2205, 3204 and 3205 have been described in order to engage the PCB locks 1200, 3200 and 6200 on a PCB, the present invention is not limited to this. Alternatively, or in addition, any configuration that allows engagement and prevents disengagement of the PCB locks 1200 and 3200 on the PCB, or with the element which has to be connected to the configured electrical connector, can be used instead.

1-13. (canceled)

14. A configurable electrical connector including at least one engaging means for engaging at least one lock in at least two positions, the at least one lock being for mounting the connector to a mounting target.

15. The configurable electrical connector according to claim 14, wherein the at least one engaging means is configured so as to allow engagement/prevents disengagement of the lock with/from the configurable electrical connector.

16. The configurable electrical connector according claim 14, wherein the at least one engaging means has a plurality of protrusions separated by at least one space, wherein at least one of the protrusion is provided with locking means configured so as to allow engagement/prevents disengagement of the lock with/from the configurable electrical connector.

17. The configurable electrical connector according to claim 14, wherein the at least one engaging means has a circular section.

18. The configurable electrical connector according to claim 17, wherein the configurable electrical connector further comprises at least one rotating stop, and the lock comprises at least one indentation, such that the lock can be engaged with the configurable electrical connector in at least one position when the at least one rotating stop is inserted into the at least one indentation.

19. The configurable electrical connector according to claim 14, wherein at least one engaging means has a section such that, once the lock is engaged with the configurable electrical connector, the lock is prevented from rotating on the at least one engaging means.

20. The configurable electrical connector according to claim 19, wherein the section is configured to allow the lock to be engaged on the configurable electrical connector in at least two positions.

21. A lock for a configurable electrical connector according to claim 14, for mounting the configurable electrical connector on a mounting target, the lock comprising a hole with a section substantially similar to the section of the at least one engaging means of the configurable electrical connector.

22. The lock according to claim 21, further comprising a mounting pin for engaging the at least one lock to the mounting target.

23. The lock according to claim 22, wherein the mounting pin comprises at least one locking means for preventing disengagement of the lock from the mounting target.

24. The lock according to claim 21, further comprising at least one stopping means for stopping movement of the lock toward the mounting target.

25. The lock according claim 21, further comprising at least one coding means for determining the mounting direction of the lock on the mounting target.

26. A configured electrical connector including a configurable electrical connector according to claim 14, and at least one lock according to claim 21.
